(19) United States
(12) Patent Application Publication
(10) Pub. No.: US 2021/0380229 A1
(43) Pub. Date: Dec. 9, 2021

(54) REDUCED WEIGHT AIRCRAFT TIRE

(71) Applicant: The Goodyear Tire & Rubber Company, Akron, OH (US)

(72) Inventor: Kiyoshi Ueyoko, Copley, OH (US)

(21) Appl. No.: 17/409,020

(22) Filed: Aug. 23, 2021

Related U.S. Application Data
(63) Continuation-in-part of application No. 16/687,747, filed on Nov. 19, 2019.

(51) Int. Cl. B64C 25/36

(52) U.S. Cl. CPC B64C 25/36

(57) ABSTRACT

A pneumatic tire having a carcass and a belt reinforcing structure wherein the belt reinforcing structure is a composite belt structure having at least one radially inner spiral layer and at least one zigzag belt reinforcing structure located radially outward of said spiral layer. The zigzag belt width is preferably wider than the spiral layer. The pneumatic tire further includes an auxiliary belt layer wherein the auxiliary belt is a zigzag belt formed of a dual modulus strip formed of two different reinforcement cords, and wherein the auxiliary belt may be the widest belt layer.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

Pneumatic tires for high speed applications experience a high degree of flexure in the crown area of the tire as the tire enters and leaves the area of the footprint. This problem is particularly exacerbated on aircraft tires wherein the tires can reach speed of over 200 mph at takeoff and landing.

When a tire spins at very high speeds the crown area tends to grow in dimension due to the high angular accelerations and velocity, tending to pull the tread area radially outwardly. Counteracting these forces is the load of the vehicle which is only supported in the small area of the tire known as the footprint area.

Current tire design drivers are an aircraft tire capable of high speed, high load and with reduced weight. It is known in the prior art to use zigzag belt layers in aircraft tires, such as disclosed in the Watanabe, U.S. Pat. No. 5,427,167. Zigzag belt layers have the advantage of eliminating cut belt edges at the outer lateral edge of the belt package. The inherent flexibility of the zigzag belt layers also helps improve cornering forces. However, a tire designed with zigzag belt layers cannot carry as heavy a load as required by current commercial aircraft design requirements. Further, there is generally a tradeoff between load capacity and weight. Thus, an improved aircraft tire is needed, which is capable of meeting high speed, high load and with reduced weight.

### Definitions

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

The invention will be described by way of example and with reference to the accompanying drawings in which:

FIG. 1 is a schematic cross-sectional view of a first embodiment of half of a tire according to the invention;

FIG. 2 is a schematic perspective view of a zigzag belt layer in the middle of the formation;

FIG. 3 is a schematically enlarged top view of a geodesic cut protector belt;

FIG. 4 is a schematic cross-sectional view of a second embodiment of half of a tire according to the invention;

FIG. 5A is a first embodiment of a dual modulus strip;

FIG. 5B is a second embodiment of a dual modulus strip;

FIG. 5C is a third embodiment of a dual modulus strip; and

FIG. 6 is a schematic of a merged cord.

### DETAILED DESCRIPTION OF THE INVENTION

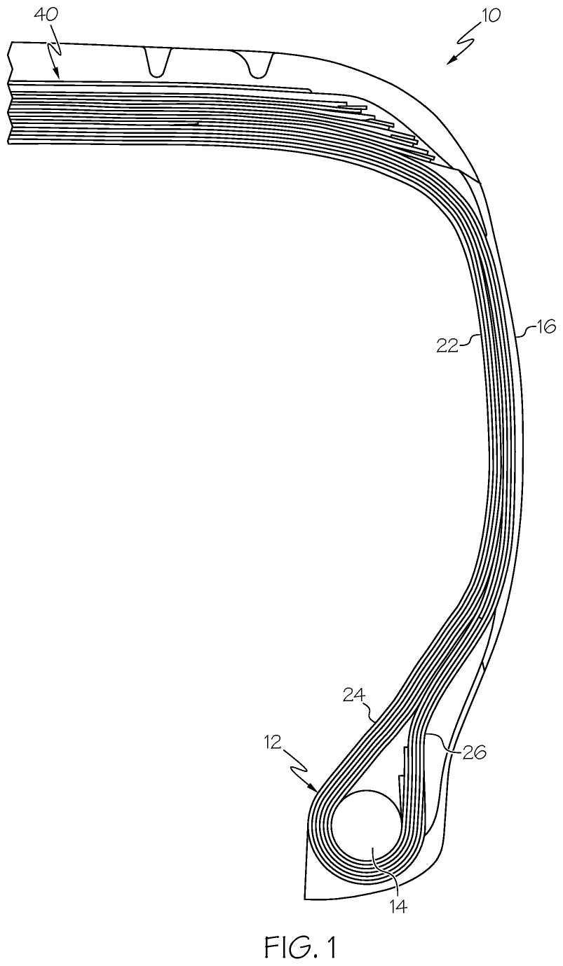

FIG. 1 illustrates a cross-sectional view of one half of a radial aircraft tire 10 of the present invention. The tire is symmetrical about the mid-circumferential plane so that only one half is illustrated. As shown, the aircraft tire comprises a pair of bead portions 12 each containing a bead core 14 embedded therein. One example of a bead core suitable for use in an aircraft tire is shown in U.S. Pat. No. 6,571,847. The bead core 14 preferably has an aluminum, aluminum alloy or other light weight alloy in the center portion surrounded by a plurality of steel sheath wires. A person skilled in the art may appreciate that other bead cores may also be utilized.

The aircraft tire further comprises a sidewall portion 16 extending substantially outward from each of the bead portions 12 in the radial direction of the tire, and a tread portion 20 extending between the radially outer ends of the sidewall portions 16. Furthermore, the tire 10 is reinforced with a carcass 22 toroidally extending from one of the bead portions 12 to the other bead portion 12. The carcass 22 is comprised of inner carcass plies 24 and outer carcass plies 26, preferably oriented in the radial direction. Among these carcass plies, typically four inner plies 24 are wound around the bead core 14 from inside of the tire toward outside thereof to form turnup portions, while typically two outer plies 26 are extended downward to the bead core 14 along the outside of the turnup portion of the inner carcass ply 24. Each of these carcass plies 24,26 may comprise any suitable cord, typically nylon cords such as nylon-6,6 cords extending substantially perpendicular to an equatorial plane EP of the tire (i.e., extending in the radial direction of the tire). Preferably the nylon cords have an 1890 denier/2/2 or 1890 denier/3 construction. One or more of the carcass plies 24, 26 may also comprise an aramid and nylon cord structure, for example, a hybrid cord, a high energy cord or a merged cord. Examples of suitable cords are described in U.S. Pat. Nos. 4,893,665, 4,155,394, or U.S. Pat. No. 6,799,618.

### Main Belt Layer

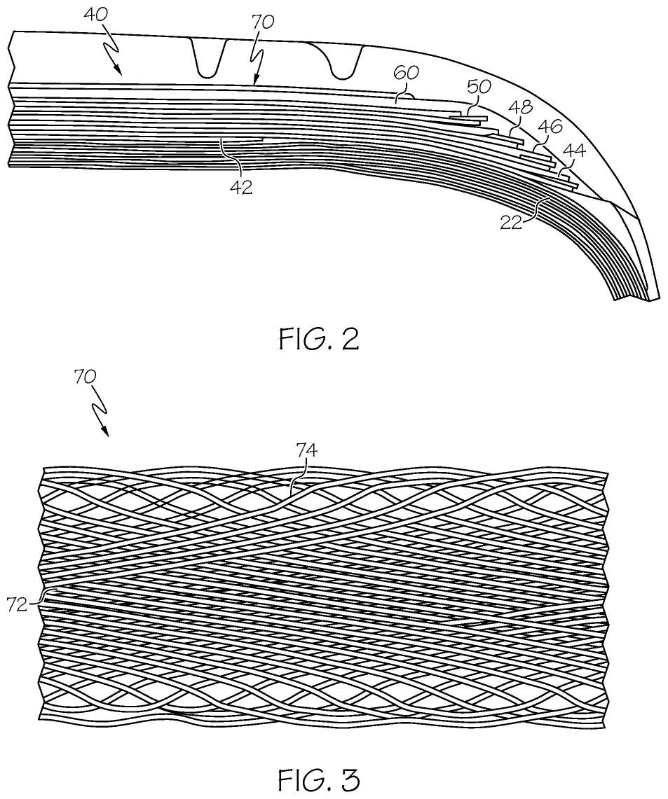

The aircraft tire 10 further comprises a main belt package 40 arranged between the carcass 22 and the tread rubber 20. FIG. 2 illustrates a first embodiment of one half of a belt package 40 suitable for use in the aircraft tire. The main belt package 40 is symmetrical about the mid-circumferential plane so that only one half of the belt package is illustrated. The main belt package 40 as shown comprises a plurality of belt layers located adjacent the carcass. The belt layers are arranged to have decreasing width, with the radially outermost belt having the least width, and the radially innermost belt having the greatest width. The radially innermost belt 42 is preferably a low angle belt layer, with an angle less than 10 degrees. More preferably, the radially innermost belt is less than 5 degrees, and is helically wound. The width of the low angle belt in preferably in the range of 40% to 100% of the widest belt width.

The main belt layer 40 further includes one or more zigzag belt layers 44. Preferably, there are at least two zigzag belt layers 44,46. More preferably, there are three zigzag belt layers 44,46,48. The angle of the zigzag belt layers range from ten degrees to 40 degrees. The zigzag belt layers are formed by winding a strip of one or more cords in a zigzag pattern on a drum. The main belt layers are preferably formed from a hybrid or merged cord of nylon and aramid. More preferably, the main belt cord construction is 3000 d/2 aramid and 1680 d/1 nylon.

The belt package 40 further comprises an auxiliary belt layer 50 located radially outward of the main belt layer 50. The auxiliary belt layer 50 is preferably a zigzag belt layer formed of nylon cords having a 1890d/4 cord construction. The angle of the zigzag belt layer may range from 10 degrees to 40 degrees. The second belt layer has a width less than the main belt layer 40.

A cushion gum layer 60 is located radially outward of the auxiliary belt layer 50. The cushion gum layer 60 is formed from a stiff rubber compound, and preferably has a modulus of elasticity of 20-22 mpa.

A cut protector belt 70 is located radially outward of the cushion gum layer 60. The cut protector belt may be formed of nylon, but is preferably made of a hybrid or merged cord of nylon and aramid. Preferably, the cut protector belt 70 is formed of a merged cord having a 3000d/2 Aramid, and 1680d/1 nylon cord construction which are twisted together to form a merged cord. The cut protector belt may be a zigzag belt or more preferably, a geodesic belt. The geodesic belt is shown in FIG. 3, and is made by the process described in U.S. Pat. No. 9,199,512 which is hereby incorporated by reference in its entirety. The geodesic belt is selected to have a dense amount of cords in the crown region 72 of the belt, with a reduced density of cords in the lateral belt edges 74.

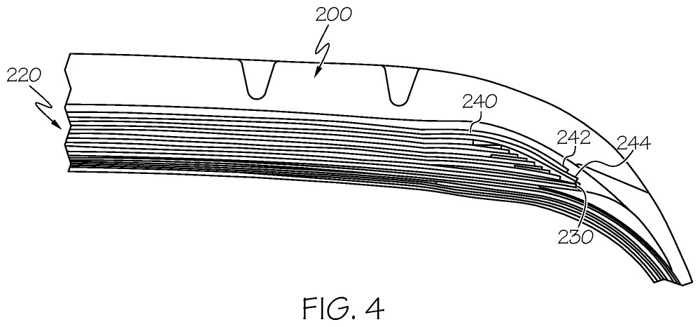

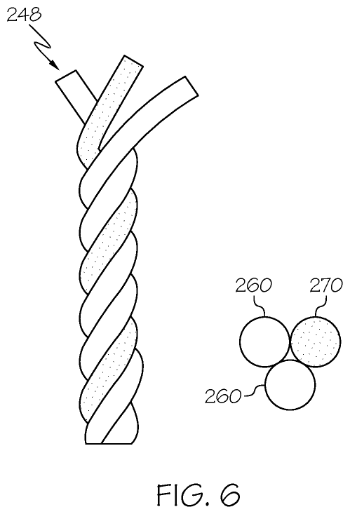

FIG. 4 illustrates a second embodiment of an aircraft tire 200 of the present invention. The aircraft tire 200 includes a main belt package 220 that includes a plurality of zigzag belt layers. The zigzag belt layers are preferably formed of merged cord of aramid and nylon reinforcement cords twisted together as shown in FIG. 6. One or more low angle belt layers 230 having an angle less than 10 degrees may be located radially inward of the zigzag belt layers. The one or more low angle belts are preferably spirally wound and formed of merged reinforcement cords.

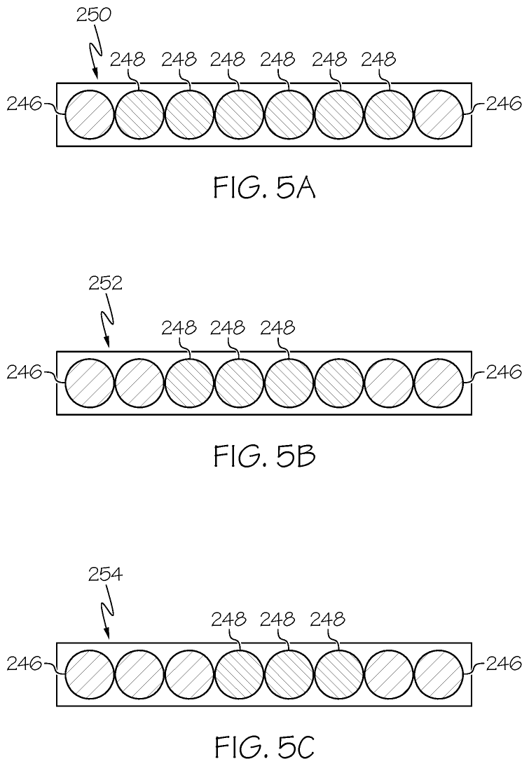

An auxiliary belt layer 240 is located radially outward of the main belt package 220. The auxiliary belt layer 240 is preferably a zigzag belt layer formed of a dual modulus strip of reinforcement cords as shown in FIGS. 5A-5C. As shown in FIG. 5A, the dual modulus strip 250 is approximately 0.5 inch width and has a single nylon reinforcement cord at each lateral end of the strip 250. The dual modulus strip 250 further includes a plurality of merged cords 248 located between the nylon reinforcement cords 246. As shown in FIG. 6, the merged cord 248 is formed of two aramid reinforcement cords 260 and a nylon cord 270 twisted together. FIG. 5B illustrates a second example of a dual modulus strip 252 having at least two outer cords formed of nylon 246 and a plurality of merged cords located therebetween. FIG. 5C illustrates an asymmetric dual modulus strip, having an uneven number of nylon reinforcement cords on one end, and an even number of nylon reinforcement cords on the opposite end. The asymmetric dual modulus strip 254 has a plurality of merged cords 248 located therebetween the nylon cords. As shown in FIG. 4, there may be two layers of auxiliary belts. The auxiliary belts may be the axially widest belt, and have outer lateral belt ends 242,244 that overlay the belt ends of the zigzag belts of the main belt layer.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having a carcass and a belt reinforcing structure, the belt reinforcing structure comprising:
a main belt structure, wherein the main belt structure includes a first belt layer having cords arranged at an angle of 5 degrees or less with respect to the midcircumferential plane, and a first zigzag belt reinforcing structure, the first zigzag belt reinforcing structure forming two layers of cords, the cords inclined at 5 to 30 degrees relative to the centerplane of the tire extending in alternation to turnaround points at each lateral edge, wherein the first zigzag belt reinforcing structure is wider than the first belt layer;
said belt reinforcing structure further comprising an auxiliary belt located radially outward of the main belt, wherein the auxiliary belt is a zigzag belt formed of a dual modulus strip formed of two different reinforcement cords; and
said belt reinforcing structure further comprising a cut protector belt located radially outward of the auxiliary layer, wherein the cut protector belt is a geodesic belt.

2. The pneumatic tire of claim 1 wherein the two different reinforcement cords of the dual modulus strip are not wrapped together.

3. The pneumatic tire of claim 1 wherein the dual modulus strip has a plurality of reinforcement cords, and a nylon reinforcement cord located at each lateral end.

4. The pneumatic tire of claim 1 wherein the dual modulus strip is formed of a plurality of reinforcement cords having a merged cord construction of nylon and aramid twisted together.

5. The pneumatic tire of claim 4 wherein the dual modulus strip has a nylon reinforcement cord at each lateral end.

6. The pneumatic tire of claim 1 wherein the dual modulus strip has an odd number of nylon cords at one end.

7. The pneumatic tire of claim 1 wherein the dual modulus strip has an odd number of nylon cords at one end, and an even number of nylon cords at the opposite lateral end.

8. The pneumatic tire of claim 1 wherein the auxiliary belt is the widest belt layer and has outer lateral ends that fold over the main belt package.
